(19) United States
(12) Patent Application Publication
(10) Pub. No.: US 2019/0093642 A1
(43) Pub. Date: Mar. 28, 2019

(54) RECIPROCATING AXIAL PUMP

(71) Applicant: SCHAEFFLER TECHNOLOGIES AG & CO. KG, HERZOGENAURACH (DE)

(72) Inventor: Jeffrey HEMPHILL, Copley, OH (US)

(21) Appl. No.: 15/717,245

(22) Filed: Sep. 27, 2017

(51) Int. Cl. F04B 17/04; F04B 1/02; F04B 9/06; F04B 19/22; F04B 49/06; F16H 61/00

(52) U.S. Cl. CPC F04B 17/04; F04B 1/02; F04B 9/06; F04B 53/10; F04B 49/06; F16H 61/0031; F04B 19/22

(57) ABSTRACT

A transmission pump comprising a pair of pistons located in corresponding chambers of the pump, the pistons configured to move fluid located in the chamber. The transmission pump also includes one or more return springs located in at least one of the chambers and configured to move the pair of pistons. The transmission pump also includes an electrical coil located adjacent the pair of pistons, wherein the coil is configured to produce a magnetic flux to move the pistons and springs.

### TECHNICAL FIELD

The present disclosure relates to pumps utilized in a transmission of a vehicle.

### BACKGROUND

Automobiles may be required to meet fuel economy targets. To help meet those targets, vehicles may be equipped with automatic transmissions that utilize start-stop systems. Such start-stop systems shut the engine off when, for example, the vehicle is motionless for a certain duration. When the engine is shut off, a hydraulic pump in the automatic transmission may stop turning and the transmission may come out of gear. Electrically driven auxiliary pumps may be used to prevent the transmissions from coming out of gear.

### SUMMARY

According to a first embodiment, a transmission pump comprises a pair of pistons located in corresponding chambers of the pump, the pistons configured to move fluid located in the chamber. The transmission pump also includes one or more return springs located in at least one of the chambers and configured to move the pair of pistons. The transmission pump also includes an electrical coil located adjacent the pair of pistons, wherein the coil is configured to produce a magnetic flux to move the pistons and springs.

According to a second embodiment, a transmission pump comprises one or more pistons located in one or more corresponding chambers of the pump, the one or more pistons configured to move fluid located in the corresponding chamber and reciprocate along a stator. The transmission pump further includes one or more springs located in the chamber and configured to move the one or more pistons, and an electrical coil located adjacent the one or more of pistons, wherein the coil is configured to produce a magnetic flux in response to a signal from a semiconductor to move the one or more pistons and springs.

A third embodiment discloses a method of moving fluid using a pump in a transmission of a vehicle comprising, in response to power from a semiconductor, powering an electrical coil located adjacent a pair of pistons each in corresponding chambers. The method further includes producing a magnetic flux from the electrical coil and in response to the magnetic flux, moving a pair of pistons located in corresponding chambers of the pump. The method further discloses reciprocating the pair of pistons utilizing springs.

### BRIEF DESCRIPTION OF THE DRAWINGS

FIG. 1 is a schematic side view of a transmission with parts broken away to show a pump mounted to the transmission.

FIG. 2 is a cross-section of an embodiment of a reciprocating axial pump.

FIG. 3 is a cross-section of another embodiment of a reciprocating axial pump.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

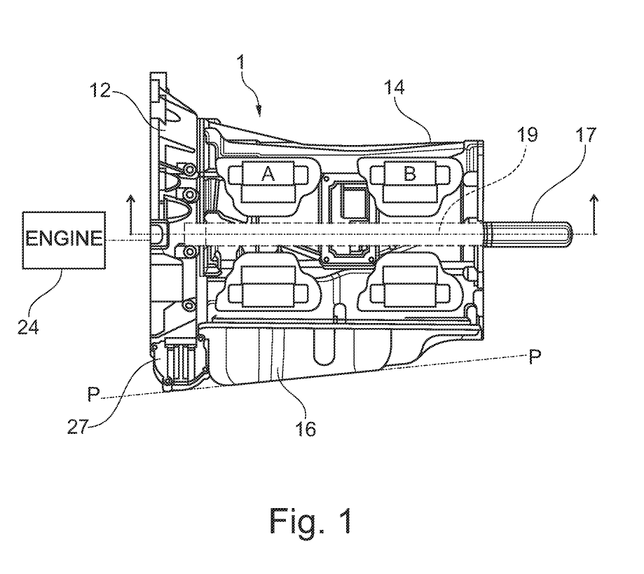

FIG. 1 is a schematic side view of one example of a transmission 1, with certain structural features omitted to show a pump mounted to the transmission. An engine 24 may generate compression pulses during start and/or stop modes of operation. The transmission 1 may include a transmission main housing 14. A pump 27 may be utilized to pump hydraulic fluid to shifting clutches within a transmission when the engine is not operating. In an alternate embodiment, the pump 27 may be utilized to pump hydraulic fluid to a torsional damper assembly when the engine is not operating.

The transmission 1 may include an input housing 12 and main housing 14 with dual electric motors (A, B), which are indirectly journaled onto the main shaft 19 of the transmission 1 through a series of planetary gear sets (not shown). The motors (A, B) operate with selectively engaged clutches (not shown) to rotate the output shaft 17. The oil pan 16 may be located on the base of the main housing 14 and may be configured to provide oil volume for the transmission 1 and its components. The projection line P-P of the oil pan 16 defines ground clearance for the vehicle, as shown in FIG. 1. The main housing 14 may cover inner components of the transmission such as the electric motors (A, B), planetary gear arrangements, the main shaft 19 and clutches (not shown). The input housing 12 is bolted directly to the rear face of a block of the engine 24 and encases the transmission components that mechanically interface with the engine 24. The input housing 12 may support an auxiliary pump 27, which may be mounted to the base of the input housing 12 and secured nestably adjacent the oil pan 16 and above the projection line P-P.

The pump 27 may be configured to supply a lubricant (e.g. oil, hydraulic fluid, or other lubricants) to the shifting clutches when the engine 24 is off, thereby providing transmission clutch pressure and lubrication. The pump 27 may lie within or adjacent the oil pan 16 and above the projection line P-P of the oil pan (or an imaginary line extrapolated from the bottom of the oil pan 16) so that the pump 27 may not require additional ground clearance.

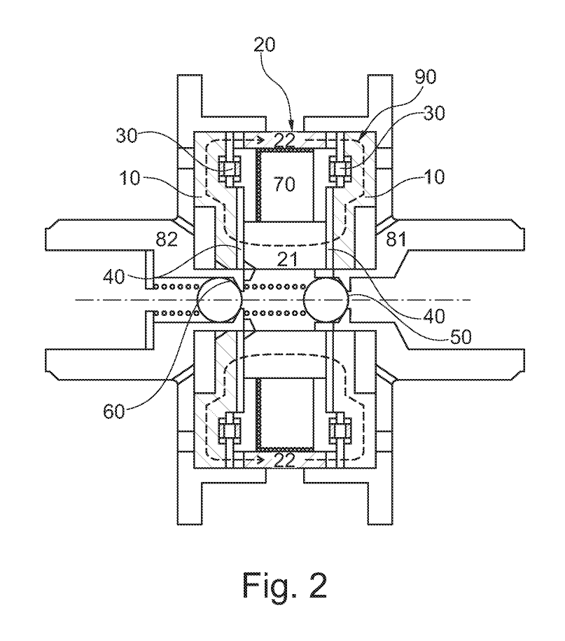

FIG. 2 is a cross-section of an embodiment of a reciprocating axial pump that can be used as the pump 27 of FIG. 1. The pump may operate by moving pistons 10 axially by using a magnetic force developed by a stator 20. Springs 30 may return the pistons to their top position. The springs 30 may also generate a suction to fill the piston chambers 40. While FIG. 2 illustrates a pump with two pistons, any number of pistons may be used. For example, only one piston may be used or three or four pistons may be used. Additional pistons may allow for more continuous flow of fluid into the valve body of the transmission when a vehicle engine is off. Additionally, additional valves (e.g. check valves) may be utilized than exemplified. For example, each piston may be configured to have their own inlet and outlet valve system. Thus, two or more pistons may utilize two or more valves.

A valve system may be utilized to control flow of fluid in and out of the piston's chambers. For example, two check vales may be used to control the flow of oil in and out of the chambers. One check valve may be utilized for a suction side 50, while the other check valve may be utilized for the pressure side 60. Additionally, a reed valve or other type of valve system may be utilized in the pump in other embodiments.

The pump may include housings to surround or protect various pump pieces and components. In one example, the housing may include a suction side housing 81 and a pressure side housing 82. The suction side housing 81 may include fluid (e.g. lubricant) that is received from the valve. The suction side housing 81 may be used to pull in fluid from the sump. The pressure side housing 82 may include fluid (e.g. lubricant) that exits from the piston. The pressure side housing 82 may be used to push the fluid into the valve body of the transmission. Both the pressure side and suction side housings may include check valves, as well as retain the pistons and fluid.

The stator may contain a coil 70 of wire. The coil 70 of wire may be wound around the stator. The coil 70 may be any type of ferromagnetic material, including but not limited to iron, nickel, cobalt, and alloys contain a mixture of such material with other magnetized material. The stator core 21 may be configured to create a pathway for the magnetic flux when the coil is powered or electrified. The stator core 21 may use various materials, such as a mild steel, laminated steel plates, powdered metal (e.g. high performance for conducting), a sintered structure, and other similar metals or alloys. When electricity is passed through the coil 70, a magnetic field may be formed surrounding the coil 70. The resulting flux lines 90 may pass through the stator core 21, through the air gap and into the pistons 10, through the pistons, and back through the air gap and into the outer stator 22. Based on the flux lines, the pistons are pulled toward the stator, creating pressure which opens the outlet check valve(s). When the flow of electricity is stopped, the springs 30 may be able to push the pistons back up to create a suction. The suction may open the suction side valve and allow fluid from the sump into the pump.

A circuit board or control circuitry (e.g. processor or controller) may be utilized to supply power to the coil to produce the magnetic flux. Additionally, a transistor or other type of semiconductor may be integrated on the pump with such control circuitry The circuit board may be configured to pull a voltage (e.g. 12V) from a power supply and control signal from the vehicle controller area network (CAN) bus, or a square-wave signal. If the transistor is communicating with the vehicle network via the CAN bus, a controller (e.g. transmission controller) may communicate with the transistor to send signals indicating when the transistor is powered on or off. In one scenario, a controller may send a signal via the vehicle network indicating the transistor should be powered off because the engine is running. In another scenario, a controller may send a signal via the vehicle network indicating the transistor should be powered on because the engine is off.

By applying the magnetic flux from the coils to the pistons, the pistons may be undergoing equal and opposite motion. By having the pistons being in equal and opposite motion, there may be a minimal or no imbalance of forces when fluid is being transferred into or out of the pump.

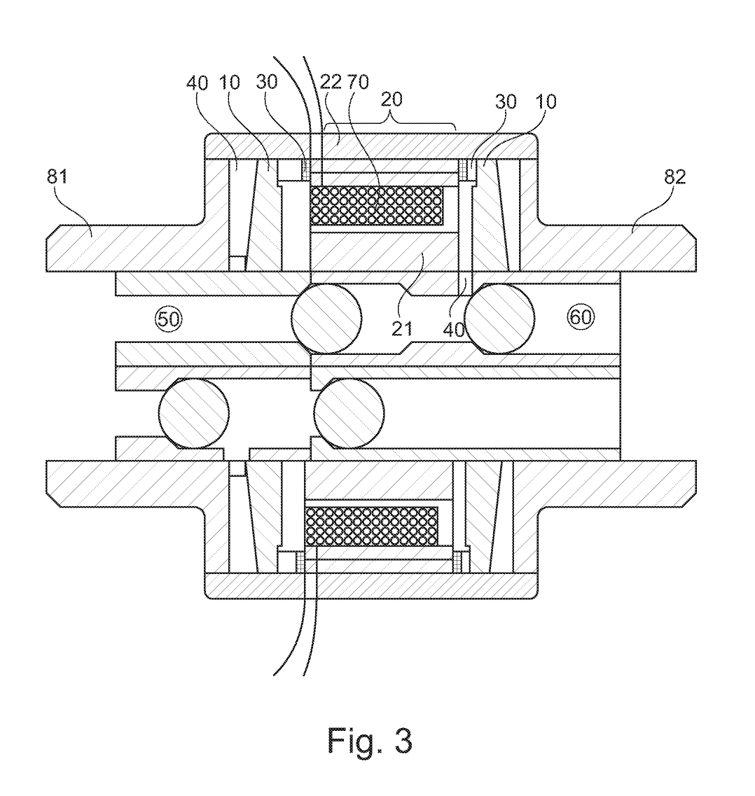

FIG. 3 is a cross-section of an alternative embodiment of a reciprocating axial pump. While the exemplary embodiment of FIG. 3 shows four valves, additional valves may be utilized. Any valve system may be utilized, such as a reed valve. The valves may be arranged so that one piston (or one group of pistons) may be utilized to create a suction while the other piston (or another group of corresponding pistons) are creating a pressure. In the alternative embodiment shown in FIG. 3, the pistons 10 may create a staccato pressure and suction at the same.

In one scenario, the coil 70 may be electrified and create an electromagnetic force. A magnetic flux as a result of the electronic force may create pressure by pulling the left-hand piston and spring shown in FIG. 3. In one example, the pistons 10 may be pulled towards the stator 20 or stator core 21 in response to the coil 70 being electrified (e.g. an electric signal being sent to the coil). When the pistons 10 are pulled towards the center, one of the pistons (e.g. left-hand side piston) may create suction or pressure. On the other hand, the right-hand side piston may be creating a vacuum. In another scenario, the coil 70 may be off and the springs 30 may create a suction. When the coil 70 is off the springs 30 may be creating pressure between the piston 10 and the housing of the pump. Thus, one of the pistons 10 may be generating a suction while the other piston may be generating a pressure. Additionally, one of the pistons 10 may be generating a pressure when the other piston is creating a suction.

The valve system corresponding with the pump described in FIG. 3 may be configured such that when the coil 70 is powered and creates a magnetic flux that allows the piston 10 to move, the pressure side of the valve may allow the piston 10 to create a pressure, while the other piston 10 may be generating a suction at the same time. In another scenario, valve system may be configured such that when the coil 70 is powered and creates a magnetic flux that allows the piston 10 to move, the suction side of the valve may allow the piston 10 to create a suction, while the other piston 10 may be generating a pressure at the same. Thus, the valve system may be configured such that when one piston is creating a suction, the other piston may be creating a pressure when a coil is powered. While the suction side 50 and pressure side 60 are shown in the opposite sides in FIG. 3 as compared to FIG. 2, both the suction side 50 and pressure side 60 may switch sides for both FIG. 2 and FIG. 3.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### LIST OF REFERENCE SYMBOLS

1 Transmission
10 Pistons
12 Input Housing
14 Main Housing
16 Oil Pan
17 Output Shaft
19 Main Shaft
20 Stator
21 Stator Core
22 Outer Stator
24 Engine
27 Pump
30 Springs
40 Piston Chambers
50 Suction Side
60 Pressure Side
70 Coil
81 Suction Side Housing
82 Pressure Side Housing
90 Flux Lines

What is claimed is:

1. A transmission pump, comprising:
a pair of pistons located in corresponding chambers of the pump, the pistons configured to move fluid located in the chamber;
one or more return springs located in at least one of the chambers and configured to move the pair of pistons; and
an electrical coil located adjacent the pair of pistons, wherein the electrical coil is configured to produce a magnetic flux to move the pistons and springs.

2. The transmission pump of claim 1, wherein the magnetic flux is configured to move the pair of pistons in a direction opposite of a compressional force of the spring.

3. The transmission pump of claim 1, wherein the electrical coil is in a stator of the transmission pump.

4. The transmission pump of claim 1, wherein the electrical coil is configured to produce a magnetic flux configured to pull the pair of pistons towards one another to compress the fluid.

5. The transmission pump of claim 1, wherein the pair of pistons are configured to move in opposite motion.

6. The transmission pump of claim 1, wherein the pair of pistons is configured to reciprocate along a stator.

7. The transmission pump of claim 6, further comprising a valve that includes a pressure side configured to push the fluid into a valve body of a transmission in response to the pair of pistons reciprocating.

8. The transmission pump of claim 1, wherein the transmission pump includes a valve that includes a suction side configured to allow fluid to enter the suction side from a sump.

9. The transmission pump of claim 1, wherein the pair of pistons are reciprocating axial pistons.

10. The transmission pump of claim 1, wherein the electrical coil is in communication with a transistor.

11. The transmission pump of claim 1, wherein the electrical coil comprises ferromagnetic material.

12. A transmission pump, comprising:
one or more pistons located in one or more corresponding chambers of the pump, the one or more pistons configured to move fluid located in the corresponding chamber and reciprocate along a stator;
one or more springs located in the chamber and configured to move the one or more pistons; and
an electrical coil located adjacent the one or more of pistons, wherein the coil is configured to produce a magnetic flux in response to a signal from a semiconductor to move the one or more pistons and springs.

13. The transmission pump of claim 12, wherein the magnetic flux is configured to move the one or more pistons in a direction opposite of a compressional force of the one or more springs.

14. The transmission pump of claim 12, wherein the one or more pistons are configured to reciprocate in opposite motion.

15. The transmission pump of claim 12, wherein the one or more pistons include a first piston and a second piston, wherein the first piston is configured to generate a suction when the second piston creates pressure.

16. The transmission pump of claim 12, wherein the one or more pistons include a first piston and a second piston, wherein the second piston is configured to generate a pressure when the first piston creates a suction.

17. The transmission pump of claim 12, wherein the semiconductor is powered when a vehicle engine is not running.

18. The transmission pump of claim 12, wherein the semiconductor is not powered when a vehicle engine is running.

19. The transmission pump of claim 12, wherein the pump further includes a stator, wherein the stator is wound by the coil.

20. A method of moving fluid using a pump in a transmission of a vehicle, comprising:
in response to power from a semiconductor, powering an electrical coil located adjacent a pair of pistons each in corresponding chambers;
producing a magnetic flux from the electrical coil;
in response to the magnetic flux, moving a pair of pistons located in corresponding chambers of the pump; and
reciprocating the pair of pistons utilizing springs.
